(19) United States
(12) Patent Application Publication
(10) Pub. No.: US 2019/0287563 A1
(43) Pub. Date: Sep. 19, 2019

(54) PERPENDICULAR MAGNETIC RECORDING MEDIUM

(71) Applicants: FUJI ELECTRIC CO., LTD., Kawasaki-shi (JP); TOHOKU UNIVERSITY, Sendai-shi (JP)

(72) Inventors: Hiroyasu KATAOKA, Kawasaki-shi (JP); Hiroto KIKUCHI, Matsumoto-shi (JP); Akira FURUTA, Matsumoto-shi (JP); Takehito SHIMATSU, Sendai-shi (JP)

(73) Assignees: FUJI ELECTRIC CO., LTD., Kawasaki-shi (JP); TOHOKU UNIVERSITY, Sendai-shi (JP)

(21) Appl. No.: 16/263,329

(22) Filed: Jan. 31, 2019

(30) Foreign Application Priority Data
Mar. 19, 2018 (JP) 2018-051303

(51) Int. Cl. G11B 5/667; G11B 5/127; G11B 5/852

(52) U.S. Cl. CPC G11B 5/667; G11B 5/852; G11B 5/1278

(57) ABSTRACT

In a perpendicular magnetic recording medium and a method of manufacturing the same, a first magnetic recording layer includes first magnetic crystal grains and a first non-magnetic portion containing carbon, a second magnetic recording layer includes second magnetic crystal grains and a second non-magnetic portion containing ZnO, a third magnetic recording layer includes third magnetic crystal grains and a third non-magnetic portion containing carbon, a film thickness t2 of the second magnetic recording layer is 0.1 nm to 7.0 nm, a volume fraction x2 of the second non-magnetic portion in the second magnetic recording layer at completion of formation is 0.20 to 0.90, a film thickness t3 of the third magnetic recording layer is 0.5 nm to 4.0 nm, a volume fraction x3 of the third non-magnetic portion in the third magnetic recording layer is 0.20 to 0.70, and (t2/t3)×(x2/x3) is 0.30 to 1.20.

### CROSS-REFERENCES TO RELATED APPLICATIONS

This application claims the benefit of the priority of Japanese Patent Application No. 2018-051303, filed Mar. 19, 2018, which is hereby incorporated by reference in its entirety.

### BACKGROUND OF THE INVENTION

### 1. Field of the Invention

The present invention relates to a magnetic recording medium, more specifically to a perpendicular magnetic recording medium using magnetic crystal grains with an ordered structure.

### 2. Description of the Related Art

In a technology of perpendicular magnetic recording in which magnetic crystal grains with an ordered structure such as an L1₀ ordered alloy is used in a magnetic recording layer, there is a magnetic recording layer having a granular structure which includes magnetic crystal grains containing the ordered alloy and a non-magnetic portion surrounding the magnetic crystal grains. For example, in a perpendicular magnetic recording medium including a magnetic recording layer containing carbon in the non-magnetic portion, carbon tends to reach upper surfaces of the magnetic crystal grains due to its high diffusion property and inhibit columnar growth of the ordered alloy. Accordingly, it is difficult to form a thick magnetic recording layer. Moreover, for example, when materials such as SiO₂ and TiO₂ are used for the non-magnetic portion, the grain isolation property and magnetic property of the magnetic crystal grains are degraded.

International Publication No. WO2015/087510 describes introducing carbon and ZnO as non-magnetic portions of a magnetic recording layer. FIG. 1 illustrates a layer structure of the magnetic recording medium described in International Publication No. WO2015/087510. The magnetic recording medium described in International Publication No. WO2015/087510 includes a non-magnetic substrate 10, an adhesion layer 20, an underlying layer 30, a seed layer 40, a magnetic recording layer 50, and a protection layer 60. The magnetic recording layer 50 has a three-layer laminated structure including first magnetic recording layers 51a, 51b and a second magnetic recording layer 52. Here, the first magnetic recording layers 51a, 51b have a granular structure which includes first magnetic crystal grains containing an ordered alloy and a first non-magnetic portion surrounding the first magnetic crystal grains and containing carbon. The second magnetic recording layer 52 has a granular structure which includes second magnetic crystal grains containing an ordered alloy and a second non-magnetic portion surrounding the second magnetic crystal grains and containing ZnO.

### SUMMARY OF THE INVENTION

In the aforementioned perpendicular magnetic recording medium described in International Publication No. WO2015/087510, ZnO is introduced as the second non-magnetic portion of the second magnetic recording layer 52. Diffusion of carbon is thereby suppressed and the second magnetic crystal grains are formed by growing in a columnar shape in an excellent manner.

In the perpendicular magnetic recording medium as described in International Publication No. WO2015/087510, when the magnetic recording layer is formed to be thick, it is necessary to surely prevent carbon from diffusing to the surfaces of the magnetic crystal grains and inhibiting the columnar growth of the magnetic crystal grains. However, the perpendicular magnetic recording medium as described above has a problem that, when the magnetic recording layer is formed to be thick and have a film thickness of, for example, 5 nm or more by forming the first magnetic recording layer 51b on the second magnetic recording layer 52, in some portions of the magnetic recording medium, the grain isolation property of the magnetic crystal grains decreases and crystal growth in random directions occurs due to excessive holding force in a plane. Note that, in this description, forming a magnetic recording layer with a film thickness of 5 nm or more is referred to as “forming a thick magnetic recording layer.”

The present invention has been made in view of the aforementioned problems and an object thereof is to provide a perpendicular magnetic recording medium using magnetic crystal grains with an ordered structure, the perpendicular magnetic recording medium including a thick magnetic recording layer which can surely prevent inhibiting of columnar growth of the magnetic crystal grains, a decrease in a grain isolation property of the magnetic crystal grains, and an increase in holding force in a plane when the thick magnetic recording layer is formed.

A perpendicular magnetic recording medium according to one aspect of the present invention is a perpendicular magnetic recording medium including a non-magnetic substrate and a magnetic recording layer formed over the non-magnetic substrate, wherein the magnetic recording layer includes a first magnetic recording layer, one or a plurality of second magnetic recording layers, and one or a plurality of third magnetic recording layers, and the one or plurality of second magnetic recording layers and the one or plurality of third magnetic recording layers are alternately stacked over the first magnetic recording layer, the first magnetic recording layer includes first magnetic crystal grains containing an ordered alloy and a first non-magnetic portion containing carbon, the second magnetic recording layer includes second magnetic crystal grains containing an ordered alloy and a second non-magnetic portion containing ZnO, the third magnetic recording layer includes third magnetic crystal grains containing an ordered alloy and a third non-magnetic portion containing carbon, a film thickness t2 of the second magnetic recording layer is 0.1 nm to 7.0 nm, a volume fraction x2 of the second non-magnetic portion in the second magnetic recording layer at completion of formation of the second magnetic recording layer is 0.20 to 0.90, a film thickness t3 of the third magnetic recording layer is 0.5 nm to 4.0 nm, a volume fraction x3 of the third non-magnetic portion in the third magnetic recording layer is 0.20 to 0.70, and (t2/t3)×(x2/x3) is 0.30 to 1.20.

For example, the magnetic recording layer may include the first magnetic recording layer, one of the second magnetic recording layer, and one of the third magnetic recording layer. For example, (t2/t3)×(x2/x3) can be 0.45 to 1.0. For example, the configuration can be such that a film thickness of the first magnetic recording layer is 0.5 nm to 4.0 nm and a volume fraction of the first non-magnetic portion in the first magnetic recording layer is 0.10 to 0.60. For example, the ordered alloys in the first magnetic recording layer, the second magnetic recording layer, and the third magnetic recording layer can be selected from the group consisting of FePt, CoPt, FePd, and CoPd. For example, the configuration may be such that the first magnetic recording layer has a granular structure which includes the first magnetic crystal grains containing the ordered alloy and the first non-magnetic portion surrounding the first magnetic crystal grains and containing carbon, the second magnetic recording layer has a granular structure which includes the second magnetic crystal grains containing the ordered alloy and the second non-magnetic portion surrounding the second magnetic crystal grains and containing ZnO, and the third magnetic recording layer has a granular structure which includes the third magnetic crystal grains containing the ordered alloy and the third non-magnetic portion surrounding the third magnetic crystal grains and containing carbon. For example, the perpendicular magnetic recording medium according to one aspect of the present invention may further include a seed layer formed between the non-magnetic substrate and the magnetic recording layer and a protection layer formed over the magnetic recording layer.

A manufacturing method of a perpendicular magnetic recording medium according to another aspect of the present invention is a manufacturing method of a perpendicular magnetic recording medium including a non-magnetic substrate and a magnetic recording layer formed over the non-magnetic substrate, wherein the magnetic recording layer includes a first magnetic recording layer, one or a plurality of second magnetic recording layers, and one or a plurality of third magnetic recording layers, and the one or plurality of second magnetic recording layers and the one or plurality of third magnetic recording layers are alternately stacked over the first magnetic recording layer, the first magnetic recording layer includes first magnetic crystal grains containing an ordered alloy and a first non-magnetic portion containing carbon, the second magnetic recording layer includes second magnetic crystal grains containing an ordered alloy and a second non-magnetic portion containing ZnO, and the third magnetic recording layer includes third magnetic crystal grains containing an ordered alloy and a third non-magnetic portion containing carbon, the manufacturing method comprising: a first step of forming the first magnetic recording layer; a second step of forming the second magnetic recording layer on the first magnetic recording layer such that a film thickness t2 of the second magnetic recording layer is 0.1 nm to 7.0 nm and a volume fraction x2 of the second non-magnetic portion in the second magnetic recording layer is 0.20 to 0.90; and a third step of forming the third magnetic recording layer on the second magnetic recording layer such that a film thickness t3 of the third magnetic recording layer is 0.5 nm to 4.0 nm and a volume fraction x3 of the third non-magnetic portion in the third magnetic recording layer is 0.20 to 0.70, wherein (t2/t3)×(x2/x3) is 0.30 to 1.20.

The manufacturing method according to the other aspect of the present invention may further include, for example, a fourth step of forming the second magnetic recording layer on the third magnetic recording layer. In the manufacturing method according to the other aspect of the present invention, the third step may be performed after the fourth step. The manufacturing method according to the other aspect of the present invention may further include a fifth step of repeating the third step and the fourth step alternately such that a top layer of the magnetic recording layer is the second magnetic recording layer or the third magnetic recording layer. For example, (t2/t3)×(x2/x3) may be 0.45 to 1.0. For example, the first step may be a step of forming the first magnetic recording layer such that a film thickness t1 of the first magnetic recording layer is 0.5 nm to 4.0 nm and a volume fraction x1 of the first non-magnetic portion in the first magnetic recording layer is 0.10 to 0.60. For example, the ordered alloys in the first magnetic recording layer, the second magnetic recording layer, and the third magnetic recording layer can be selected from the group consisting of FePt, CoPt, FePd, and CoPd. Moreover, the configuration may be such that the first magnetic recording layer has a granular structure which includes the first magnetic crystal grains containing the ordered alloy and the first non-magnetic portion surrounding the first magnetic crystal grains and containing carbon, the second magnetic recording layer has a granular structure which includes the second magnetic crystal grains containing the ordered alloy and the second non-magnetic portion surrounding the second magnetic crystal grains and containing ZnO, and the third magnetic recording layer has a granular structure which includes the third magnetic crystal grains containing the ordered alloy and the third non-magnetic portion surrounding the third magnetic crystal grains and containing carbon. For example, the manufacturing method may further include a step of forming a seed layer between the non-magnetic substrate and the magnetic recording layer and a step of forming a protection layer on the magnetic recording layer.

According to the one aspect of the present invention, it is possible to provide the perpendicular magnetic recording medium which can surely prevent carbon from diffusing to surfaces of the magnetic crystal grains and inhibiting columnar growth of the magnetic crystal grains and also prevent a decrease in the degree of order of the magnetic crystal grains when the thick magnetic recording layer is formed.

Further features of the present invention will become apparent from the following description of exemplary embodiments with reference to the attached drawings.

### BRIEF DESCRIPTION OF THE DRAWINGS

FIG. 1 is a cross-sectional view illustrating a conventional perpendicular magnetic recording medium;

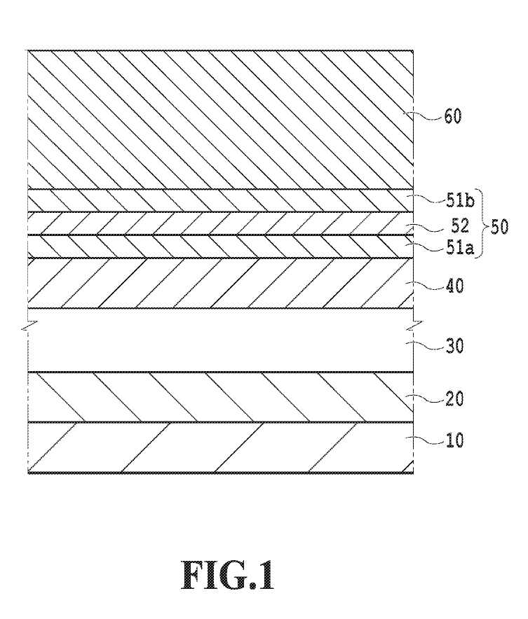

FIGS. 2A to 2D are views for explaining a mechanism of carbon covering upper surfaces of magnetic crystal grains in the conventional perpendicular magnetic recording medium;

FIG. 3 is a cross-sectional view illustrating a perpendicular magnetic recording medium according to the present invention;

FIGS. 4A to 4D are views for explaining a mechanism of preventing carbon from covering the upper surfaces of the magnetic crystal grains in the perpendicular magnetic recording medium according to the present invention;

FIG. 5 is a view for explaining a manufacturing method of forming a magnetic recording layer 150 in the perpendicular magnetic recording medium according to the present invention;

FIG. 6 is a view illustrating an evaluation result of the magnetic recording medium for each of plotted points of a volume ratio x2/x3 and a film thickness ratio t2/t3;

FIGS. 7A to 7C are views illustrating states of the crystal grains in the magnetic recording mediums corresponding to the respective plotted points of the volume ratio x2/x3 and the film thickness ratio t2/t3; and

FIGS. 8A and 8B are views illustrating states of order in the magnetic recording mediums corresponding to the respective plotted points of the volume ratio x2/x3 and the film thickness ratio t2/t3.

### DETAILED DESCRIPTION OF THE INVENTION

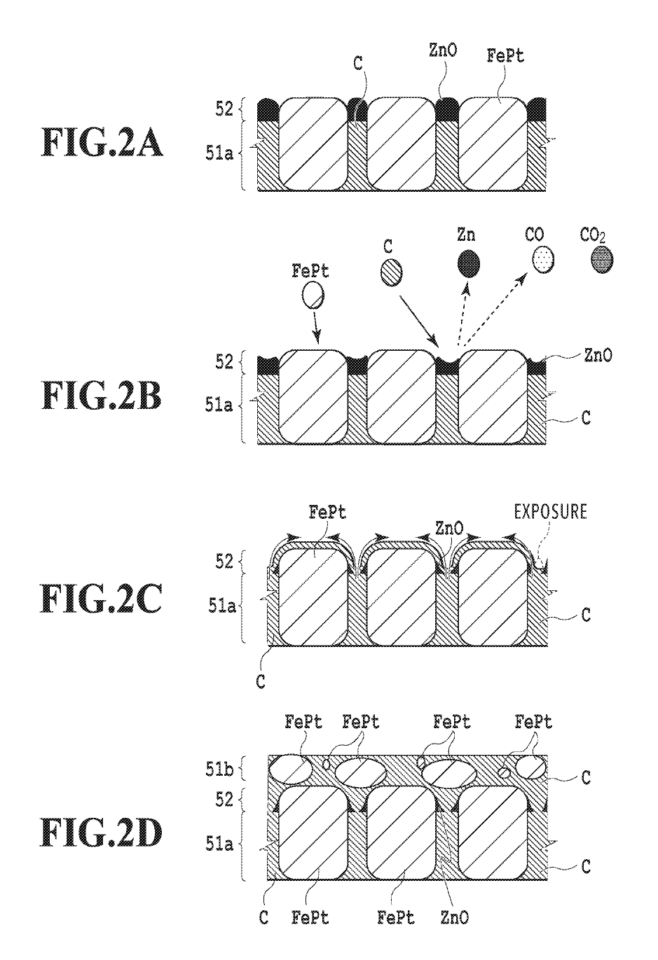

FIGS. 2A to 2D are schematic views of a conventional magnetic recording layer with a granular structure which includes magnetic crystal grains containing an ordered alloy and a non-magnetic portion surrounding the magnetic crystal grains. Description is given of a mechanism of carbon covering upper surfaces of the magnetic crystal grains in a conventional perpendicular magnetic recording medium, by using FIGS. 2A to 2D. FIGS. 2A to 2D illustrate a layer configuration in which FePt—C is used for first magnetic recording layers 51a, 51b and FePt—ZnO is used for a second magnetic recording layer 52, the FePt—C being a configuration in which an ordered alloy contained in the layer is FePt and a non-magnetic portion is carbon (C), the FePt—ZnO being a configuration in which an ordered alloy contained in the layer is FePt and a non-magnetic portion is ZnO.

As illustrated in FIG. 2A, when the second magnetic recording layer 52 is formed on the first magnetic recording layer 51a, multiple FePt magnetic crystal grains grow in a columnar shape by being magnetically isolated from one another by carbon (C) in the first magnetic recording layer 51a and ZnO in the second magnetic recording layer 52. Thereafter, as illustrated in FIG. 2B, sputtering film formation using a target containing FePt and carbon (C) is performed in a reduced pressure to form the first magnetic recording layer 51b on the second magnetic recording layer 52. Then, redox of carbon (C) and ZnO in the second magnetic recording layer 52 occurs and Zn and CO or CO₂ are thereby generated. Since the vapor pressure of Zn is low, Zn is vaporized during the formation of the first magnetic recording layer 51b and, with this vaporization, ZnO in the second magnetic recording layer 52 disappears. Then, as illustrated in FIG. 2C, carbon (C) in the non-magnetic portion of the first magnetic recording layer 51a below the portion where ZnO disappears is thus exposed to a non-magnetic portion being formed. When carbon (C) in the lower first magnetic recording layer 51a is exposed to the non-magnetic portion being formed, as illustrated in FIG. 2D, carbon (C) in the lower first magnetic recording layer 51a diffuses into the first magnetic recording layer 51b being formed, and spreads around and over upper surfaces of FePt in the first magnetic recording layer 51b being formed to cover the upper surfaces of FePt. The inventors made earnest studies and found out the following facts: when the thick magnetic recording layer is formed, the conventional magnetic recording medium has a problem that, although carbon (C) does not inhibit the columnar growth of all of the FePt magnetic crystal grains, carbon (C) sometimes causes a defect by locally covering the upper surfaces of the magnetic crystal grains and inhibiting the columnar growth of the FePt magnetic crystal grains.

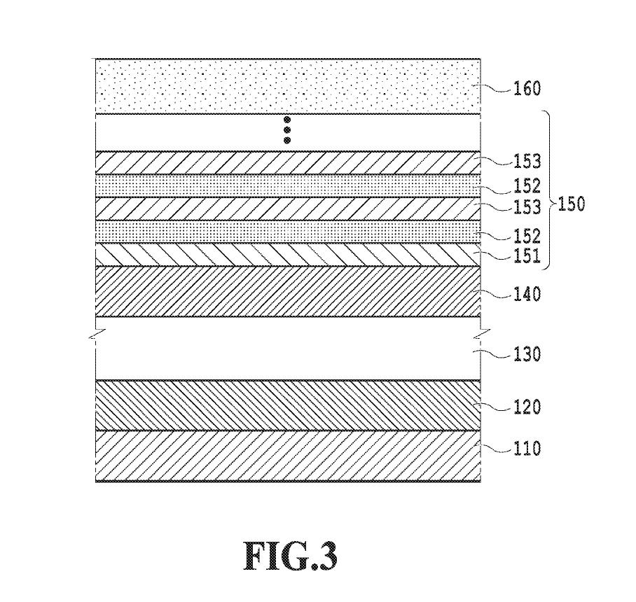

A perpendicular magnetic recording medium and a manufacturing method of the same according to the present invention are described below by using FIGS. 3 to 5.

FIG. 3 illustrates a configuration example of a magnetic recording medium according to the present invention. FIG. 3 illustrates a magnetic recording medium including a non-magnetic substrate 110, an adhesion layer 120, an underlying layer 130, a seed layer 140, a magnetic recording layer 150, and a protection layer 160. As illustrated in FIG. 3, the magnetic recording layer 150 includes a first magnetic recording layer 151, second magnetic recording layers 152, and third magnetic recording layers 153. The second magnetic recording layers 152 and the third magnetic recording layers 153 are alternately stacked over the first magnetic recording layer 151. Moreover, the first magnetic recording layer 151 and one of the second magnetic recording layers 152 are in direct contact with each other and the second magnetic recording layers 152 and the third magnetic recording layers 153 are in direct contact with one another. The top layer of the magnetic recording layer 150 may be either the second magnetic recording layer 152 or the third magnetic recording layer 153.

The magnetic recording medium according to the present invention includes the non-magnetic substrate 110, the seed layer 140, and the magnetic recording layer 150 in this order. The seed layer 140 and the magnetic recording layer 150 are preferably in direct contact with each other. The adhesion layer 120, the underlying layer 130, and the protection layer 160 illustrated in the configuration example of FIG. 3 are layers which can be selectively provided as necessary. Moreover, the magnetic recording medium in the configuration example of the present invention may further include a heat sink layer, a soft magnetic underlayer, an intermediate layer, and the like between the non-magnetic substrate 110 and the magnetic recording layer 150.

The magnetic recording layer 150 in the perpendicular magnetic recording medium according to the present invention is described below in detail.

The first magnetic recording layer 151 includes first magnetic crystal grains and a first non-magnetic portion containing carbon. The first magnetic recording layer 151 has a granular structure which includes the first magnetic crystal grains and the first non-magnetic portion surrounding the first magnetic crystal grains.

The first magnetic crystal grains are made by using an ordered alloy. The ordered alloy may contain few crystal defects or a small amount of impurities as long as the first magnetic crystal grains provide properties of the ordered alloy. The first magnetic crystal grains are preferably made by using an L1₀ ordered alloy. The usable L1₀ ordered alloy is an alloy containing at least one element selected from Fe and Co and at least one element selected from the group consisting of Pt, Pd, Au, and Ir. More preferably, the L1₀ ordered alloy is selected from the group consisting of FePt, CoPt, FePd, and CoPd. Metals such as Ni, Mn, Cr, Cu, Ag, Au, and Cr may be added to the L1₀ ordered alloy for the purpose of, for example, reducing the temperature necessary for ordering of the ordered alloy, increasing the temperature gradient of coercivity, and adjusting ferromagnetic resonance frequency for microwave. Adding Ni, Mn, and Cr reduces the magnetic interaction and changes the magnetic properties such as magnetic anisotropy and Curie temperature, and desired magnetic properties can be obtained. Moreover, adding Cu, Ag, and Au can provide effects of reducing the ordering temperature and improving the magnetic anisotropy.

The first non-magnetic portion is made of a material whose main component is carbon. Preferably, the first non-magnetic portion is made of carbon. Note that main component means that the component is contained by more than 50 vol % with respect to the entire first non-magnetic portion. B, Sc, Ti, V, Ag, and the like may be further added to the first non-magnetic portion.

The film thickness t1 of the first magnetic recording layer 151 can be 0.5 to 4.0 nm, preferably 1.0 to 2.0 nm. Setting the film thickness within this range can promote magnetic isolation and columnar growth of the first magnetic crystal grains and also reduce variance in the grain size of the first magnetic crystal grains.

In the first magnetic recording layer 151, the volume factor of the first non-magnetic portion with respect to the entire first magnetic recording layer 151 determines the grain size of the first magnetic crystal grains. The grain size of the first magnetic crystal grains is preferably 3.0 to 12 nm. To achieve this, the volume fraction x1 of the first non-magnetic portion in the first magnetic recording layer 151 can be 10 to 60 vol %, preferably 20 to 50 vol % with respect to the entire first magnetic recording layer 151. If x1 is too large, carbon tends to spread around and over the upper surfaces of the first magnetic crystal grains and portions where the columnar growth of the first magnetic crystal grains is inhibited are formed. If x1 is too small, the isolation property of the first magnetic crystal grains decreases and portions where the gain size is coarse is formed. Accordingly, employing the aforementioned volume fraction can increase the columnar growth limit film thickness of the first magnetic crystal grains while improving the orientation and the degree of order of second magnetic crystal grains in the second magnetic recording layer 152 to increase the magnetic anisotropy constant Ku of the entire magnetic recording layer 150. “Columnar growth limit film thickness” in this description means the largest film thickness of the magnetic recording layer at which the columnar growth of the magnetic crystal grains can be achieved.

Each of the second magnetic recording layers 152 includes the second magnetic crystal grains and a second non-magnetic portion containing ZnO. The second magnetic recording layer 152 has a granular structure which includes the second magnetic crystal grains and the second non-magnetic portion surrounding the second magnetic crystal grains. The second magnetic crystal grains are formed on the first magnetic crystal grains to be in contact therewith and the second non-magnetic portion is formed on the first non-magnetic portion to be in contact therewith.

The second magnetic crystal grains are made by using an ordered alloy like the first magnetic crystal grains. The ordered alloy may contain few crystal defects or a small amount of impurities as long as the second magnetic crystal grains provide properties of the ordered alloy. The second magnetic crystal grains are preferably made by using an L1₀ ordered alloy. The usable L1₀ ordered alloy is an alloy containing at least one element selected from Fe and Co and at least one element selected from the group consisting of Pt, Pd, Au, and Ir. More preferably, the L1₀ ordered alloy is selected from the group consisting of FePt, CoPt, FePd, and CoPd. Metals such as Ni, Mn, Cr, Cu, Ag, Au, and Cr may be added to the L1₀ ordered alloy for the purpose of, for example, reducing the temperature necessary for ordering of the ordered alloy, increasing the temperature gradient of coercivity, and adjusting ferromagnetic resonance frequency for microwave. Adding Ni, Mn, and Cr reduces the magnetic interaction and changes the magnetic properties such as magnetic anisotropy and Curie temperature, and desired magnetic properties can be obtained. Moreover, adding Cu, Ag, and Au can provide effects of reducing the ordering temperature and improving the magnetic anisotropy.

The second non-magnetic portion is made of a material whose main component is ZnO. Preferably, the second non-magnetic portion is made of ZnO. ZnO may include few lattice defects, particularly, a small amount of oxygen deficiency. Note that main component means that the component is contained by more than 50 vol % with respect to the entire second non-magnetic portion. Oxides such as SiO₂, TiO₂, and GeO₂ may be further added to the second non-magnetic portion.

The film thickness t2 of the second magnetic recording layer 152 can be 0.1 to 7.0 nm, preferably 0.2 to 4.0 nm. The volume fraction x2 of the second non-magnetic portion with respect to the entire second magnetic recording layer 152 at the completion of the formation of the second magnetic recording layer 152 is preferably equal to or higher than the volume fraction x1 of the first non-magnetic portion with respect to the entire first magnetic recording layer 151. More preferably, the volume fraction x2 is higher than the volume fraction x1 of the first non-magnetic portion. In addition to this condition, the volume fraction x2 can be 20 to 90 vol %, preferably 40 to 80 vol % with respect to the entire second magnetic recording layer 152.

In this description, the volume fraction x2 refers to the volume fraction at the completion of the formation of the second magnetic recording layer 152 (specifically, a set value of the volume fraction in a film forming apparatus in the formation of the second magnetic recording layer 152). The volume fraction x2 of the second magnetic recording layer 152 gradually decreases due to gradual disappearance of ZnO caused by redox in a process of forming the third magnetic recording layer 153 on the second magnetic recording layer 152. Accordingly, the volume fraction x2 just after the formation of the second magnetic recording layer 152 is different from the volume fraction of the second non-magnetic portion in the second magnetic recording layer 152 at the completion of the formation of the third magnetic recording layer 153.

Similarly, the film thickness of the second non-magnetic portion in the second magnetic recording layer also gradually decreases due to the gradual disappearance of ZnO caused by redox in the process of forming the third magnetic recording layer 153 on the second magnetic recording layer 152. Accordingly, the film thickness of the second non-magnetic portion just after the film formation is different from the film thickness of the second non-magnetic portion at the completion of the formation of the third magnetic recording layer 153. Meanwhile, the film thickness of the second magnetic crystal grains in the second magnetic recording layer 152 after the formation of the third magnetic recording layer 153 does not change from that before the formation. Accordingly, in this description, the film thickness t2 of the second magnetic recording layer 152 refers to the film thickness of the second magnetic crystal grains just after the formation of the second magnetic recording layer 152.

Each of the third magnetic recording layers 153 includes third magnetic crystal grains and a third non-magnetic portion made of carbon. The third magnetic recording layer 153 has a granular structure which includes the third magnetic crystal grains and the third non-magnetic portion surrounding the third magnetic crystal grains. The third magnetic crystal grains are formed over the second magnetic crystal grains and the third non-magnetic portion is formed over the second non-magnetic portion. Preferably, the third magnetic crystal grains are formed directly above the second magnetic crystal grains to be in contact therewith and the third non-magnetic portion is formed directly above the second non-magnetic portion to be in contact therewith.

The third magnetic crystal grains are made by using an ordered alloy. The ordered alloy may contain few crystal defects or a small amount of impurities as long as the third magnetic crystal grains provide properties of the ordered alloy. The third magnetic crystal grains are preferably made by using an L1₀ ordered alloy. The usable L1₀ ordered alloys include alloys such as FePt, CoPt, FePd, and CoPd which contain at least one element selected from Fe and Co and at least one element selected from the group consisting of Pt, Pd, Au, and Ir. Metals such as Ni, Mn, Cr, Cu, Ag, Au, and Cr may be added to the L1₀ ordered alloy for the purpose of, for example, reducing the temperature necessary for ordering of the ordered alloy, increasing the temperature gradient of coercivity, and adjusting ferromagnetic resonance frequency for microwave. Adding Ni, Mn, and Cr reduces the magnetic interaction and changes the magnetic properties such as magnetic anisotropy and Curie temperature, and desired magnetic properties can be obtained. Moreover, adding Cu, Ag, and Au can provide effects of reducing the ordering temperature and improving the magnetic anisotropy.

The third non-magnetic portion is made of a material whose main component is carbon. Preferably, the third non-magnetic portion is made of carbon. Note that main component means that the component is contained by more than 50 vol % with respect to the entire third non-magnetic portion. B, Sc, Ti, V, Ag, and the like may be further added to the third non-magnetic portion.

When the second magnetic recording layer 152 is formed on the first magnetic recording layer 151 and the third magnetic recording layer 153 is formed on the second magnetic recording layer 152, the third magnetic recording layer can satisfy the following relationships. The film thickness t3 of the third magnetic recording layer 153 can be 0.5 to 4.0 nm, preferably 1.0 to 2.0 nm. The volume factor x3 of the third non-magnetic portion with respect to the entire third magnetic recording layer 153 is preferably equal to or higher than the volume fraction x1 of the first non-magnetic portion with respect to the entire first magnetic recording layer 151. More preferably, the volume fraction x3 is higher than the volume fraction x1 of the first non-magnetic portion. In addition to this condition, the volume fraction x3 can be 20 to 70 vol %, preferably 30 to 60 vol % with respect to the entire third magnetic recording layer 153.

Furthermore, when the third magnetic recording layer 153 is formed directly above the second magnetic recording layer 152 to be in contact therewith, ratios of the film thickness and the volume fraction between these layers can satisfy the following relationships. The second magnetic recording layer 152 and the third magnetic recording layer 153 are configured such that a product (t2/t3)×(x2/x3) of the ratio t2/t3 of the film thickness t2 of the second magnetic recording layer 152 to the film thickness t3 of the third magnetic recording layer 153 and the ratio x2/x3 of the volume fraction x2 of the second non-magnetic portion just after the film formation to the volume fraction x3 of the third non-magnetic portion is 0.3 to 1.2 (formula (1)). The second magnetic recording layer 152 and the third magnetic recording layer 153 are preferably configured such that the product (t2/t3)×(x2/x3) is 0.45 to 1.0 (formula (2)).

0.3<(t2/t3)×(x2/x3)<1.2 formula (1)

0.45<(t2/t3)×(x2/x3)<1.0 formula (2)

The first to third magnetic crystal grains are preferably made of the same constitutional elements. This is because using the same constitutional elements promotes epitaxial growth of the first to third magnetic crystal grains and improves the degree of order of the ordered alloy.

The substrate temperature in the formation of the first to third magnetic recording layers 151 to 153 is preferably within a range of 300 to 500° C. Employing the substrate temperature within this range can improve the degree of order of the L1₀ ordered alloy in the first to third magnetic crystal grains. Moreover, the gas pressure in the film forming apparatus is preferably 0.1 Pa to 20 Pa (20 kg/m·s²). More preferably, the gas pressure in the film forming apparatus is 1 Pa to 5 Pa.

As described above, the perpendicular magnetic recording medium according to the present invention is configured such that the film thickness t2 of the second magnetic recording layer 152 and the volume fraction x2 of the second non-magnetic portion in the second magnetic recording layer 152 at the completion of the formation of the second magnetic recording layer 152, the film thickness t3 of the third magnetic recording layer 153, and the volume fraction x3 of the third non-magnetic portion in the third magnetic recording layer 153 are values within the predetermined ranges and the product (t2/t3)×(x2/x3) is a value within the predetermined range. This can achieve an appropriate balance between the supply amount of carbon supplied from the target in the formation of the third magnetic recording layer 153 and the amount of ZnO in the second magnetic recording layer 152. The amount of ZnO disappearing due to redox and the amount carbon deposited as the third magnetic recording layer 153 can be thereby adjusted to appropriate amounts. This allows the supplied carbon to be deposited on the second non-magnetic portion while causing ZnO in the second non-magnetic portion of the second magnetic recording layer 152 to remain without completely disappearing. Accordingly, it is possible to make the magnetic recording layer thick without carbon in the non-magnetic portion below the second magnetic recording layer 152 being exposed to the third magnetic recording layer 153. Note that, when the second magnetic recording layer 152 is formed over the third magnetic recording layer 153 and no third magnetic recording layer 153 is formed in contact with and directly above this second magnetic recording layer 152, the case where carbon in the third non-magnetic portion causes ZnO in the second non-magnetic portion to disappear does not occur. Accordingly, there is no need to satisfy formula (1) and formula (2).

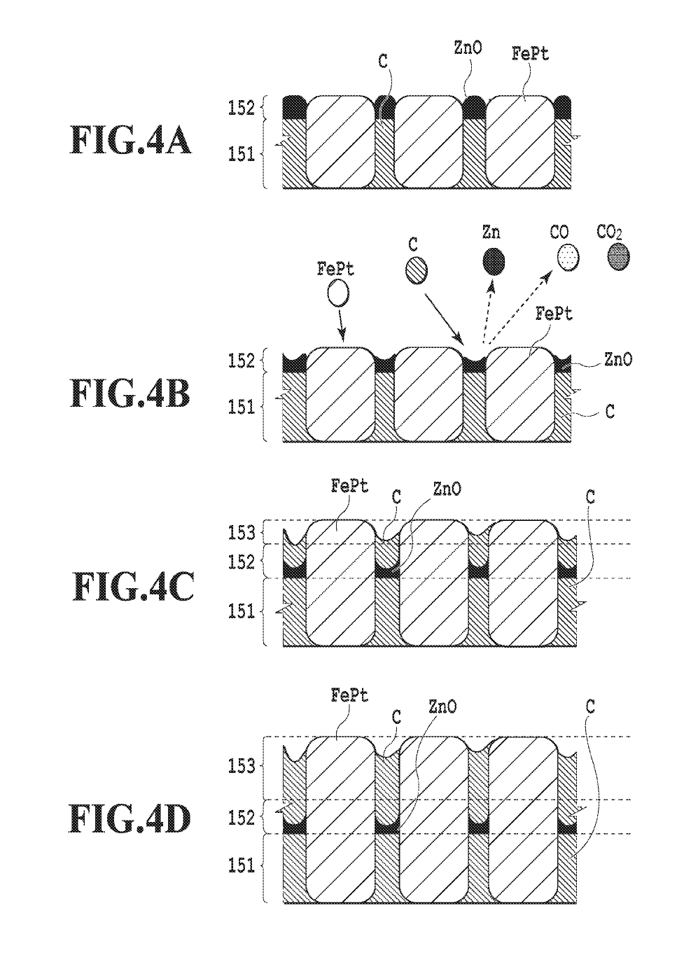

By using FIGS. 4A to 4D, description is given of a mechanism of preventing carbon (C) from covering the upper surfaces of the magnetic crystal grains in the perpendicular magnetic recording medium according to the present invention. FIGS. 4A to 4D illustrate a layer configuration in which FePt—C is used for the first magnetic recording layer 151 and the third magnetic recording layer 153 and FePt—ZnO is used for the second magnetic recording layer 152, the FePt—C being a configuration in which the ordered alloy contained in the layers is FePt and the non-magnetic portion is carbon (C), the FePt—ZnO being a configuration in which the ordered alloy contained in the layer is FePt and the non-magnetic portion is ZnO.

FIG. 4A illustrates an example in which multiple FePt magnetic crystal grains are grown in a columnar shape by being magnetically isolated from one another by carbon (C) in the first magnetic recording layer 151 and ZnO in the second magnetic recording layer 152. Then, as illustrated in FIG. 4B, when a sputtering method using a target containing FePt and carbon (C) is performed to form the third magnetic recording layer 153 on the second magnetic recording layer 152, redox of carbon (C) in the target and ZnO in the second magnetic recording layer 152 occurs and Zn and CO or CO₂ are thereby generated. Since the vapor pressure of Zn is lower than the gas pressure in the formation of the third magnetic recording layer 153, Zn is vaporized during the formation of the third magnetic recording layer 153 and, with this vaporization, ZnO in the second magnetic recording layer 152 disappears.

However, forming the second magnetic recording layer 152 and the third magnetic recording layer at the aforementioned ratios allows carbon (C) in the third magnetic recording layer 153 to be deposited on the second non-magnetic portion while causing ZnO in the second non-magnetic portion of the second magnetic recording layer 152 to remain without completely disappearing as illustrated in FIG. 4C. Formation of the third magnetic recording layer 153 can be thereby completed before carbon (C) in the first non-magnetic portion of the first magnetic recording layer 151 is exposed to the third magnetic recording layer 153. Accordingly, as illustrated in FIG. 4D, the first non-magnetic portion in the first magnetic recording layer 151 and the third non-magnetic portion in the third magnetic recording layer 153 are isolated from each other. Thus, it is possible to make the magnetic recording layer thick while preventing carbon (C) in the first non-magnetic portion from spreading around and over the surface of FePt.

Note that FIGS. 4A to 4D illustrate the example in which the magnetic recording layer 150 includes three layers and the first magnetic recording layer 151, the second magnetic recording layer 152, and the third magnetic recording layer 153 are formed in this order to be in direct contact with one another. The configuration of the magnetic recording layer 150 is not limited to this. For example, the configuration of the magnetic recording layer 150 may be a four-layer configuration in which another second magnetic recording layer 152 is formed on the aforementioned three-layer configuration to be in direct contact therewith. Moreover, the configuration of the magnetic recording layer 150 may be a configuration with five or more layers in which the second magnetic recording layer 152 and the third magnetic recording layer 153 are alternately stacked on the aforementioned three-layer configuration to be in direct contact with one another. Furthermore, the top surface of the magnetic recording layer 150 may be either the second magnetic recording layer 152 or the third magnetic recording layer 153. In any of the cases, the formula (1) is satisfied when the third magnetic recording layer 153 is stacked over the second magnetic recording layer 152. Preferably, the formula (2) is satisfied.

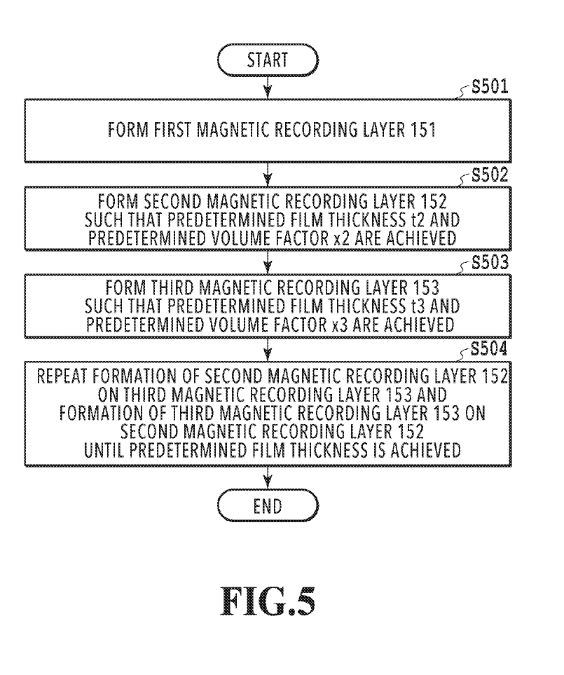

Description is given of a manufacturing method of forming the magnetic recording layer 150 in the perpendicular magnetic recording medium according to the present invention, by using FIG. 5. The magnetic recording layer 150 is formed over the non-magnetic substrate 110. Layers such as the adhesion layer 120, the underlying layer 130, the seed layer 140, the heat sink layer, the soft magnetic underlayer, and the intermediate layer can be selectively formed as necessary between the non-magnetic substrate 110 and the magnetic recording layer 150.

In the formation of the magnetic recording layer 150, in step S501, the first magnetic recording layer 151 is formed over the non-magnetic substrate 110. The first magnetic recording layer 151 is preferably formed by the sputtering method. The gas pressure in the film forming apparatus is preferably 0.1 Pa to 20 Pa. The gas pressure in the film forming apparatus is more preferably 1 Pa to 5 Pa. Moreover, the first magnetic recording layer 151 is preferably formed with the non-magnetic substrate 110 heated to a range of 300 to 500° C. The volume fraction of the first non-magnetic portion to the first magnetic recording layer 151 is 10 to 60 vol %, preferably 20 to 50 vol % with respect to the entire first magnetic recording layer 151.

Next, in step S502, the second magnetic recording layer 152 is formed on the first magnetic recording layer 151 formed in step S501 to have a film thickness t2 of 0.1 to 7.0 nm, preferably 0.2 to 4.0 nm. The volume fraction x2 of the second non-magnetic portion in the second magnetic recording layer 152 is preferably equal to or higher than the volume fraction x1 of the first non-magnetic portion in the first magnetic recording layer 151. More preferably, the volume fraction x2 is higher than the volume fraction x1 of the first non-magnetic portion. In addition to this condition, the second magnetic recording layer 152 is formed such that the volume fraction x2 is 20 vol % or more and 90 vol % or less, preferably, 40 vol % or more and 80 vol % or less with respect to the entire second magnetic recording layer 152. The second magnetic recording layer 152 is preferably formed by the sputtering method. The gas pressure in the film forming apparatus is preferably 0.1 Pa to 20 Pa. The gas pressure in the film forming apparatus is more preferably 1 Pa to 5 Pa. Moreover, the second magnetic recording layer 152 is preferably formed with the non-magnetic substrate 110 heated to a range of 300 to 500° C. The second magnetic crystal grains of the second magnetic recording layer 152 are thereby formed over the first magnetic crystal grains of the first magnetic recording layer 151.

Then, in step S503, the third magnetic recording layer 153 is formed on the second magnetic recording layer 152 formed in step S502 described above to have a film thickness t3 of 0.5 to 4.0 nm, preferably 1.0 to 2.0 nm. The volume fraction x3 of the third non-magnetic portion in the third magnetic recording layer 153 is preferably equal to or higher than the volume fraction x1 of the first non-magnetic portion in the first magnetic recording layer 151. The volume fraction x3 is more preferably higher than the volume fraction x1 of the first non-magnetic portion. In addition to this condition, the third magnetic recording layer 153 is formed such that the volume fraction x3 of the third non-magnetic portion in the third magnetic recording layer 153 is 20 vol % or more and 70 vol % or less, preferably 30 vol % or more and 60 vol % or less with respect to the entire third magnetic recording layer 153. Moreover, the third magnetic recording layer 153 is formed such that the product (t2/t3)×(x2/x3) of the ratio t2/t3 of the film thickness t2 of the second magnetic recording layer 152 to the film thickness t3 of the third magnetic recording layer 153 and the ratio x2/x3 of the volume fraction x2 of the second non-magnetic portion to the volume fraction x3 of the third non-magnetic portion is 0.3 to 1.2, preferably 0.45 to 1.0. The third magnetic recording layer 153 is preferably formed by the sputtering method involving heating of the non-magnetic substrate 110. The gas pressure in the film forming apparatus is preferably 0.1 Pa to 20 Pa. The gas pressure in the film forming apparatus is more preferably 1 Pa to 5 Pa. The third magnetic recording layer 153 is preferably formed with the non-magnetic substrate 110 heated to a range of 300 to 500° C. The third magnetic crystal grains of the third magnetic recording layer 153 are thereby formed over the second magnetic crystal grains of the second magnetic recording layer 152 and the formation of the third magnetic recording layer 153 can be completed before ZnO in the second magnetic recording layer 152 disappears and carbon in the lower layer is exposed. Accordingly, carbon in the lower layer can be prevented from spreading around and over the surfaces of the magnetic crystal grains.

In step S504, the formation of the second magnetic recording layer 152 on the third magnetic recording layer 153 and the formation of the third magnetic recording layer 153 on the second magnetic recording layer 152 may be alternately repeated in step S504 until a predetermined film thickness is obtained.

Employing the aforementioned configuration and manufacturing method can prevent carbon in the lower layer from spreading around and over the surfaces of the magnetic crystal grains in the process of forming the third magnetic recording layer 153 on the second magnetic recording layer 152 while achieving columnar growth of the first magnetic crystal grains of the first magnetic recording layer 151, the second magnetic crystal grains of the second magnetic recording layer 152, and the third magnetic crystal grains of the third magnetic recording layer 153 on a one-to-one basis. Accordingly, the magnetic crystal grains penetrating the magnetic recording layer 150 over its film thickness are formed when the thick magnetic recording layer 150 is formed. Moreover, it is possible to suppress a decrease in the degree of order of the magnetic crystal grains when the thick magnetic recording layer 150 is formed. As a result, it is possible to provide the perpendicular magnetic recording medium including the magnetic recording layer 150 with a film thickness of 5 nm or more.

Other elements included in the magnetic recording medium are described below one by one.

Various substrates with smooth surfaces can be used as the non-magnetic substrate 110. For example, the non-magnetic substrate 110 can be formed by using a material generally used for a magnetic recording medium (Al alloy plated with NiP, a reinforced glass, a glass-ceramic, or the like).

The adhesion layer 120 which can be selectively provided as necessary is used to improve adhesion between a layer formed thereon and a layer formed there below (including the non-magnetic substrate 110). When the adhesion layer 120 is provided on an upper surface of the non-magnetic substrate 110, the adhesion layer 120 can be formed by using a material with excellent adhesion with the aforementioned material of the non-magnetic substrate 110. Such materials include metals such as Ni, W, Ta, Cr, and Ru and alloys of these metals. Moreover, the adhesion layer 120 can be formed between any two layers forming the magnetic recording medium other than the non-magnetic substrate 110. The adhesion layer 120 may be one layer or have a multilayer laminated structure.

The underlying layer 130 is a layer provided to block effects of a crystal structure of a layer formed below the underlying layer 130 on the crystal orientation of the magnetic recording layer 150, the size of the magnetic crystal grains, and the like. The materials used to form the underlying layer 130 include metals such as Cr and Ta, a NiW alloy, and alloys based on Cr such as CrTi, CrZr, CrTa, and CrW. The underlying layer 130 can be formed by using any method known in this technology such as the sputtering method.

The seed layer 140 is formed between the non-magnetic substrate 110 and the magnetic recording layer 150. The seed layer 140 is preferably in direct contact with the magnetic recording layer 150. The functions of the seed layer 140 include securing adhesion between the magnetic recording layer 150 and the layer below the seed layer 140 such as the underlying layer 130 and controlling the grain size and crystal orientation of the first magnetic crystal grains and the second magnetic crystal grains in the magnetic recording layer 150 being the layer on the seed layer 140. The seed layer 140 is preferably non-magnetic. Moreover, when the magnetic recording medium including the seed layer 140 is to be used in a heat-assisted magnetic recording method, the seed layer 140 preferably functions as a thermal barrier to control temperature rise and temperature distribution in the magnetic recording layer 150. In order to control the temperature rise and temperature distribution in the magnetic recording layer 150, the seed layer 140 preferably achieves, in a balanced manner, both of a function of quickly raising the temperature of the magnetic recording layer 150 in heating of the magnetic recording layer 150 in heat-assisted recording and a function of guiding heat of the magnetic recording layer 150 to the lower layers such as the underlying layer 130 by transmitting the heat in the depth direction before the heat is transmitted in the in-plane direction of the magnetic recording layer 150.

In order to achieve the aforementioned functions, the material of the seed layer 140 is appropriately selected depending on the material of the magnetic recording layer 150. Specifically, the material of the seed layer 140 is selected depending on the material of the magnetic crystal grains in the magnetic recording layer 150. For example, when the magnetic crystal grains in the magnetic recording layer 150 is made of the L1₀ ordered alloy, the seed layer 140 is preferably formed by using a NaCl compound. In this case, the seed layer 140 can be formed by using an oxide such as MgO or SrTiO₃ or a nitride such as TiN. Moreover, the seed layer 140 can be formed by stacking multiple layers made of the aforementioned materials. The seed layer 140 is particularly preferably formed by stacking a layer containing MgO on a layer containing ZnO. The first magnetic recording layer 151 can thereby have an improved isolation property of the magnetic crystal grains and the isolation property of the magnetic crystal grains in the magnetic recording layer 150 tends to be improved when the thick magnetic recording layer 150 is formed. From the viewpoint of improving the crystalline of the magnetic crystal grains in the magnetic recording layer 150 and improving the productivity, the seed layer 140 has a thickness of 1 nm to 60 nm, preferably 1 nm to 20 nm. The seed layer 140 can be formed by using any method known in this technology such as the sputtering method (including RF magnetron sputtering method, DC magnetron sputtering method, and the like) or a vacuum deposition method.

The protection layer 160 can be formed by using a material conventionally used in the field of magnetic recording medium. Specifically, the protection layer 160 can be formed by using a non-magnetic metal such as Pt, a carbon-based material such as diamond-like carbon, or a silicon-based material such as silicon nitride. Moreover, the protection layer 160 may be a single layer or have a laminated structure. The protection layer 160 with the laminated structure may have, for example, a laminated structure of two types of carbon-based materials with different properties, a laminated structure of a metal and a carbon-based material, or a laminated structure of a metal oxide film and a carbon-based material. The protection layer 160 can be formed by using any method known in this technology such as the sputtering method (including RF magnetron sputtering method and the like) or the vacuum deposition method.

A liquid lubricant layer (not illustrated) may be selectively provided on the protection layer 160 as necessary. The liquid lubricant layer can be formed by using a material conventionally used in the field of the magnetic recording medium (for example, perfluoropolyether-based lubricant). The liquid lubricant layer can be formed by using an application method such as, for example, a dip coating method or a spin coating method.

A soft magnetic underlayer (not illustrated) may be selectively provided between the non-magnetic substrate 110 and the magnetic recording layer 150 as necessary to improve the recording-reproducing characteristics of the magnetic recording medium by controlling a magnetic flux from a magnetic head. The materials used to form the soft magnetic underlayer include crystalline materials such as a NiFe alloy, a Sendust (FeSiAl) alloy, and a CoFe alloy, microcrystalline materials such as FeTaC, CoFeNi, and CoNiP, and amorphous materials containing Co alloys such as CoZrNb and CoTaZr. The optimal value of the film thickness of the soft magnetic underlayer depends on the structure and characteristics of the magnetic head used for magnetic recording. When the soft magnetic underlayer is formed in continuous film formation with other layers, the soft magnetic underlayer preferably has a film thickness within a range 10 nm to 500 nm (inclusive) in consideration of productivity. Moreover, when the soft magnetic underlayer is provided, it is necessary that the underlying layer 130 is non-magnetic to suppress magnetic effects on the soft magnetic underlayer.

When the magnetic recording medium uses the heat-assisted magnetic recording method, a heat sink layer (not illustrated) may be provided. The heat sink layer is a layer for effectively absorbing excessive heat of the magnetic recording layer 150 generated in the heat-assisted magnetic recording. The heat sink layer can be formed by using a material with high thermal conductivity and high specific heat capacity. Such materials include simple substances of Cu, Ag, and Au and alloy materials mainly containing these substances. Here, “mainly containing” means that the amount of the material contained is 50 wt % or more. Moreover, from the viewpoint of strength and the like, the heat sink layer can be formed by using an Al—Si alloy, a Cu—B alloy, or the like. Moreover, it is possible to form the heat sink layer by using the Sendust (FeSiAl) alloy, the soft-magnetic CoFe alloy, or the like and cause the heat sink layer to have a function of the soft magnetic underlayer (function of concentrating the perpendicular magnetic field generated by the head at the magnetic recording layer 150). The optimal value of the film thickness of the heat sink layer varies depending on the heat amount and heat distribution in the heat-assisted magnetic recording, the layer configuration of the magnetic recording medium, and thickness of each layer forming the magnetic recording layer. For example, when the heat sink layer is formed in continuous film formation with other layers forming the magnetic recording layer, the film thickness of the heat sink layer is preferably 10 nm or more and 100 nm or less in consideration of productivity. The heat sink layer can be formed by using any method known in this technology such as the sputtering method (including DC magnetron sputtering method and the like) or the vacuum deposition method. Generally, the heat sink layer is formed by using the sputtering method. The heat sink layer can be provided, for example, between the non-magnetic substrate 110 and the adhesion layer 120 or between the adhesion layer 120 and the underlying layer 130 in consideration of the characteristics required for the magnetic recording medium.

### Example 1

A chemically strengthened glass substrate with a smooth surface (N-10 glass substrate manufactured by Hoya Corporation) was cleaned to prepare the non-magnetic substrate 110. The cleaned non-magnetic substrate 110 was introduced into a sputtering apparatus. A DC magnetron sputtering method using a pure Ta target was performed in an Ar gas at a pressure of 0.3 Pa to form the adhesion layer 120 made of Ta and having a film thickness of 5 nm.

The laminate in which the adhesion layer 120 was formed was subjected to a RF sputtering method using a MgO target in the Ar gas at a pressure of 0.1 Pa to form the intermediate layer made of MgO and having a film thickness of 1 nm. The applied RF power was 200 W.

Next, a DC magnetron sputtering method using a pure Cr target was performed in the Ar gas at a pressure of 0.3 Pa to form the underlying layer 130 made of Cr and having a film thickness of 20 nm.

Then, the substrate was heated to 400° C. and a RF sputtering method using a MgO target was performed in the Ar gas at a pressure of 0.1 Pa to form the seed layer 140 made of MgO and having a film thickness of 5 nm. The applied RF power was 200 W.

Next, the laminate in which the seed layer 140 was formed was heated to 450° C. and a DC magnetron sputtering method using a target containing Fe₅₀Pt₅₀ and carbon was performed in the AR gas at a pressure of 1.5 Pa to form the first magnetic recording layer 151 made of FePt—C and having a film thickness of 2.0 nm. The composition of the Fe₅₀Pt₅₀—C target was adjusted such that the composition of the obtained first magnetic recording layer 151 was 70 vol % Fe₅₀Pt₅₀ and 30 vol % C. The applied DC power was 40 W.

Then, a DC magnetron sputtering method using a target containing Fe₅₀Pt₅₀ and ZnO was performed in the Ar gas at a pressure of 1.5 Pa while the laminate in which the layers up to the first magnetic recording layer 151 were formed was heated to 450° C. to form the second magnetic recording layer 152 made of FePt—ZnO and having a film thickness of 1.0 nm. Here, the composition of the Fe₅₀Pt₅₀—ZnO target was adjusted such that the composition of the second magnetic recording layer 152 obtained at the completion of the formation of the second magnetic recording layer was 60 vol % Fe₅₀Pt₅₀ and 40 vol % ZnO. The applied DC power was 40 W.

Next, a DC magnetron sputtering method using a target containing Fe₅₀Pt₅₀ and carbon was performed in the Ar gas at a pressure of 1.5 Pa while the laminate in which the layers up to the second magnetic recording layer 152 were formed was heated to 450° C. to form the third magnetic recording layer 153 made of FePt—C and having a film thickness of 2.0 nm. Here, the composition of the Fe₅₀Pt₅₀—C target was adjusted such that the composition of the third magnetic recording layer 153 obtained at the completion of the formation of the second magnetic recording layer was 60 vol % Fe₅₀Pt₅₀ and 40 vol % C. The applied DC power was 40 W.

Finally, a DC magnetron sputtering method using a Pt target was performed in the Ar gas at a pressure of 0.3 Pa at a substrate temperature of 25° C. to form the protection layer 160 made of Pt and having a film thickness of 3 nm and the magnetic recording medium was obtained.

The magnetic recording medium in which the film thickness of the magnetic recording layer 150 was 5.0 nm and (t2/t3)×(x2/x3) of the magnetic recording layer 150 was 0.5 was thereby obtained.

In the perpendicular magnetic recording medium according to Example 1 obtained as described above, when the thick granular magnetic layer is formed, it is possible to prevent carbon from diffusing to the surface of FePt and inhibiting the columnar growth of FePt and to also prevent a decrease in the degree of order of the granular magnetic layer.

### Example 2

The adhesion layer 120, the intermediate layer, the underlying layer 130, and the seed layer 140 were sequentially formed over the non-magnetic substrate 110 as in Example 1 described above.

Next, as in Example 1 described above, the first magnetic recording layer 151 was formed on the laminate in which the seed layer 140 was formed and then the second magnetic recording layer 152 and the third magnetic recording layer 153 described above were formed. Furthermore, alternate stacking of the second magnetic recording layer 152 and the third magnetic recording layer 153 described above were repeated in the same conditions as those in Example 1 described above. Three second magnetic recording layers 152 and three third magnetic recording layers 153 were thereby alternately stacked over the first magnetic recording layer 151 and the magnetic recording layer 150 with a total film thickness of 11 nm was formed.

Finally, a DC magnetron sputtering method using a Pt target was performed in the Ar gas at a pressure of 0.3 Pa at a substrate temperature of 25° C. to form the protection layer 160 made of Pt and having a film thickness of 3 nm and the magnetic recording medium was obtained.

The magnetic recording medium in which the film thickness of the magnetic recording layer 150 was 11.0 nm and (t2/t3)×(x2/x3) of the magnetic recording layer 150 was 0.5 was thereby obtained.

In the perpendicular magnetic recording medium according to Example 2 obtained as described above, when the thick granular magnetic layer is formed, it is possible to prevent carbon from diffusing to the surface of FePt and inhibiting the columnar growth of FePt and to also prevent a decrease in the degree of order of the granular magnetic layer.

### Example 3

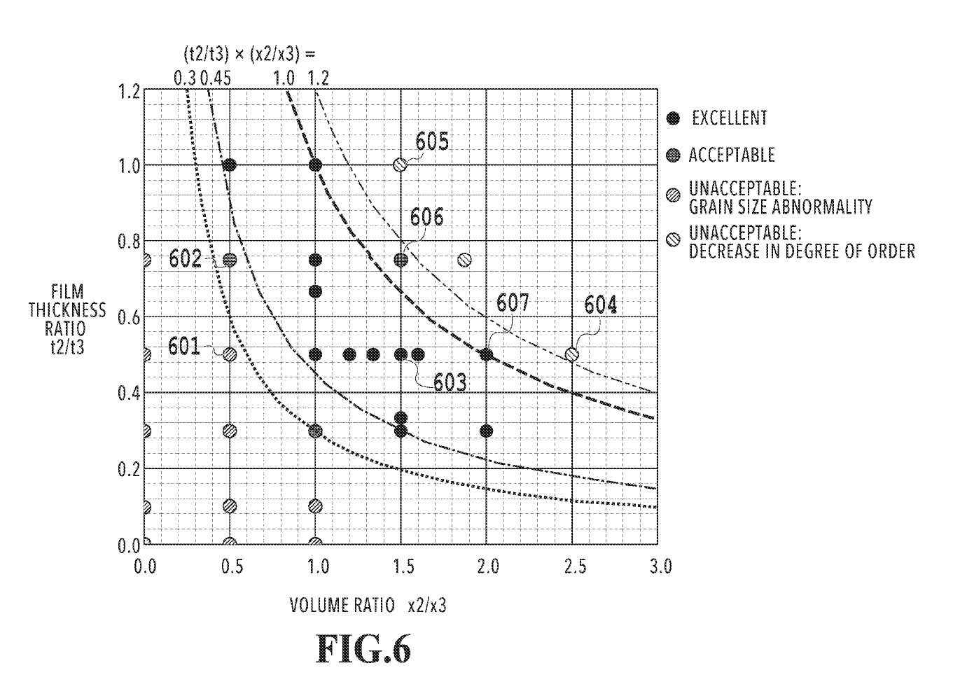

The volume ratio x2/x3 of the volume fraction x2 of the second non-magnetic portion just after the formation to the volume fraction x3 of the third non-magnetic portion and the film thickness ratio t2/t3 of the film thickness t2 of the second magnetic recording layer 152 to the film thickness t3 of the third magnetic recording layer 153 which are illustrated in FIG. 6 were studied as described below to explain the results obtained by evaluating the state of the crystal grains of the magnetic recording medium and the state of order. First, the method of forming samples with various volume fractions x2, x3 and various film thicknesses t2, t3 is described and then results of evaluating these samples are described.

### (Sample Forming)

First, the adhesion layer 120, the intermediate layer, the underlying layer 130, and the seed layer 140 were sequentially formed over the non-magnetic substrate 110 as in Example 1 described above.

Then, the magnetic recording layer 150 with three to nine layers was formed on the laminate in which the seed layer 140 was formed. The magnetic recording layer 150 with three to nine layers was formed by repeating alternate stacking of the second magnetic recording layer 152 and the third magnetic recording layer 153 over the first magnetic recording layer 151 one to four times.

The first magnetic recording layer 151 was formed to be Fe₅₀Pt₅₀—C. The amount of carbon in the first magnetic recording layer 151 was adjusted to be within a certain value between 20 vol % and 50 vol %. Moreover, the film thickness of the first magnetic recording layer 151 was 2 nm.

Each second magnetic recording layer 152 was formed to be Fe₅₀Pt₅₀—ZnO. The amount of ZnO was adjusted to be a certain value between 0 vol % and 100 vol % at the completion of the formation of the second magnetic recording layer 152. Moreover, the film thickness of the second magnetic recording layer 152 was adjusted to be a certain value between 0.2 to 2.0 nm.

Each third magnetic recording layer 153 was formed to be Fe₅₀Pt₅₀—C. The amount of carbon was adjusted to be a certain value between 30 vol % and 60 vol % at the completion of the formation of the third magnetic recording layer 153. Moreover, the film thickness of the third magnetic recording layer 153 was adjusted to be a certain value between 1.0 to 3.0 nm.

### (Evaluation Results)

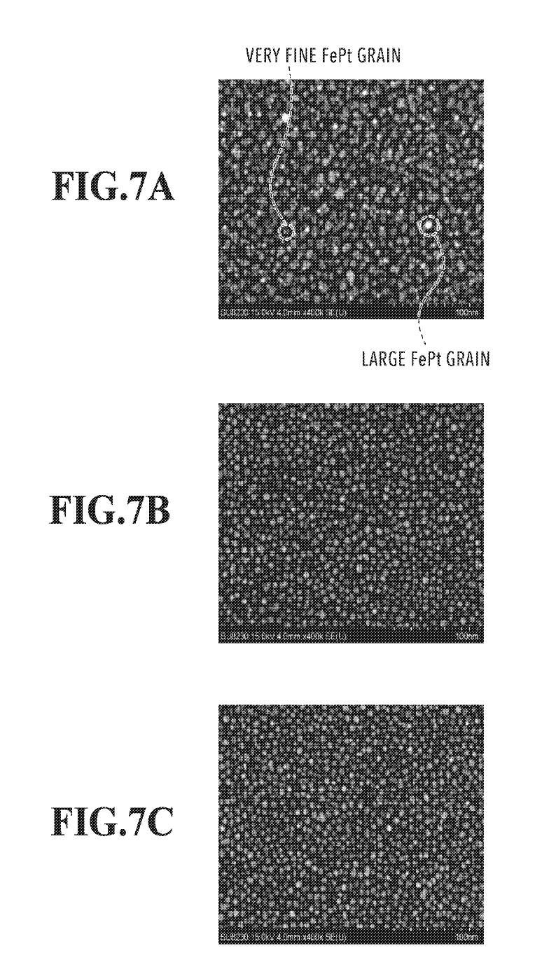

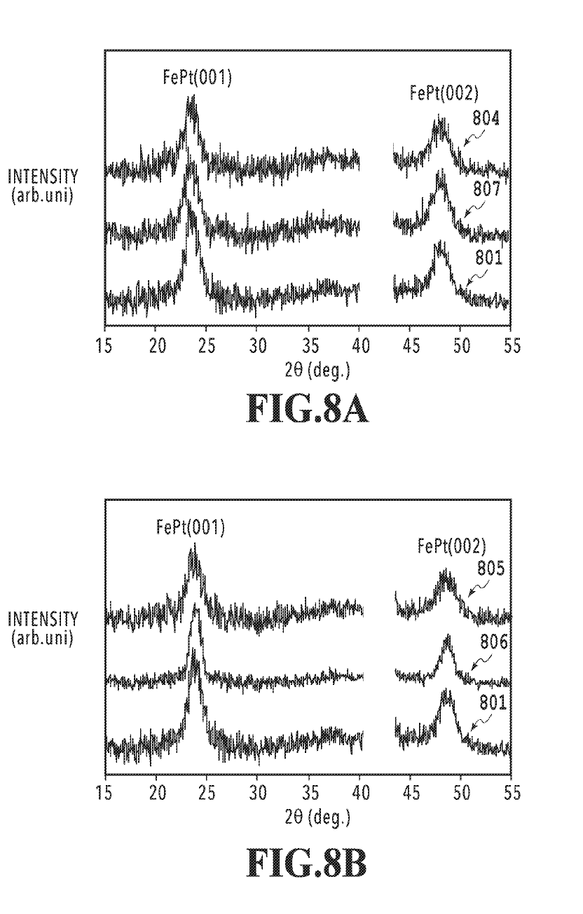

Description is given of results of evaluating the state of the crystal grains in the magnetic recording medium and the state of order at each set of the volume ratio x2/x3 and the film thickness ratio t2/t3 by using FIGS. 6 to 8B. FIG. 6 illustrates the result of evaluating the magnetic recording mediums corresponding to the respective plotted points of the volume ratio x2/x3 and the film thickness ratio t2/t3. Moreover, FIGS. 7A to 7C illustrate the states of the crystal grains in the magnetic recording mediums corresponding to the respective plotted points of the volume ratio x2/x3 and the film thickness ratio t2/t3. FIGS. 8A and 8B illustrate evaluation results of thin film XRD corresponding to the respective plotted points of the volume ratio x2/x3 and the film thickness ratio t2/t3.

In the results illustrated in FIGS. 7A to 7C, the shapes of the crystal grains were evaluated by observing a film surface parallel to the substrate with a scanning electron microscope (SEM) in a direction perpendicular to the substrate. The SEM observation was performed at a magnification of 400,000 times with acceleration voltage of 15 kV. Note that no protection layers 160 were formed for the samples used in the SEM observation to evaluate the crystal grains in the magnetic recording layers 150. A sample needs to have a fine and uniform grain structure to be employed as the magnetic recording medium.

In the results illustrated in FIGS. 8A and 8B, the order of each magnetic recording layer 150 was evaluated by means of thin film XRD (X-ray Diffraction). In the thin film XRD, a FePt (001) peak and a FePt (002) peak due to the FePt crystal were observed and the integrated intensity of each peak was first calculated to evaluate the order of the magnetic recording layer 150. Next, there were calculated a value (IN1) of a ratio of the integrated intensity of the FePt (001) peak to the measured integrated intensity of the FePt (002) peak and a value (IN2) of a ratio of the integrated intensity of the FePt (001) peak to the theoretically-calculated integrated intensity of the FePt (002) in the case where complete order is achieved. It is possible to obtain the degree of order S by dividing the value (IN1) obtained by the aforementioned measurement by the theoretically-calculated value (IN2). When the degree of order S obtained as described above is 0.5 or more, the sample has magnetic anisotropy high enough to be practically used as the magnetic recording medium. Moreover, when the degree of order S obtained as described above is 0.6 or more, an excellent magnetic recording medium with low noise can be obtained. Meanwhile, when the degree of order S is less than 0.5, the sample has a poor signal noise ratio (SNR) and cannot be employed as the magnetic recording medium.

When (t2/t3)×(x2/x3) is less than 0.3 as in the plotted point 601 illustrated in FIG. 6, a fine and uniform grain structure is not maintained. Accordingly, such a sample cannot be employed as the magnetic recording medium. For example, FIG. 7A shows a SEM photograph for the plotted point 601. As in the SEM picture of FIG. 7A, large FePt grains and very fine FePt grains (white dots) are observed. It is assumed that this because the columnar growth is inhibited by the disappearing of ZnO.

In the region where (t2/t3)×(x2/x3) is 0.3 or more as in the plotted point 602 illustrated in FIG. 6, a fine and uniform grain structure is observed. Accordingly, such a sample can be employed as the magnetic recording medium. Furthermore, in the region where (t2/t3)×(x2/x3) is 0.45 or more as in the plotted points 603 and 604 illustrated in FIG. 6, finer and more uniform grain structures are observed. For example, FIGS. 7B and 7C show SEM photographs for the plotted points 603 and 604. As in the SEM photographs in FIGS. 7B and 7C, the FePt grains have fine and uniform grain structures. Moreover, very fine FePt grains (white dots) are hardly observed. It is assumed that this is because the columnar growth is maintained.

In the evaluation results illustrated in FIG. 6, the evaluation results in which the degrees of order S are 0.5 or more and less than 0.6 are depicted to be acceptable, the evaluation results in which the degrees of order S are 0.6 or more are depicted to be excellent, and the evaluation results in which the degrees of order S are less than 0.5 are depicted to be unacceptable, the degrees of order S obtained from the results of thin film XRD whose examples are illustrated in FIGS. 8A and 8B.

When (t2/t3)×(x2/x3) is greater than 1.2 as in the plotted points 604 and 605 illustrated in FIG. 6, the degree of order S is less than 0.5 and the SNR is poor. Accordingly, such a sample cannot be employed as the magnetic recording medium. For example, 804 in FIGS. 8A and 805 in FIG. 8B illustrate the results for the plotted points 604 and 605. As in 804 and 805, the height of the FePt (001) peak relative to the FePt (002) peak is smaller than a theoretical value and the degree of order S is less than 0.5. A magnetic recording medium in this region has a low degree of order of the magnetic grains in the perpendicular direction as described above and thus has a poor signal noise ratio (SNR) as the perpendicular magnetic recording medium. Accordingly, such a magnetic recording medium cannot be employed as the perpendicular magnetic recording medium.

In the region where (t2/t3)×(x2/x3) is 1.2 or less as in the plotted points 601, 606, and 607 illustrated in FIG. 6, the degree of order S is 0.5 or more. A magnetic recording medium in this region has excellent anisotropy in the perpendicular direction as the perpendicular magnetic recording medium and can be employed as the perpendicular magnetic recording medium. For example, the results for the plotted points 601, 606, and 607 are illustrated in 801, 806, and 807 of FIGS. 8A and 8B. As illustrated in 801, 806, and 807 of FIGS. 8A and 8B, the FePt (001) peaks are sufficiently larger than the FePt (002) peaks and the degrees of order S are 0.5 or more.

Moreover, in the region where (t2/t3)×(x2/x3) is 1.0 or less as in plotted points 601 and 607 illustrated in FIG. 6, the degree of order S is 0.6 or more as in 801 and 807 of FIG. 8A. Accordingly, the amount of noise component is very small and a magnetic recording medium in this region can be more preferably employed as the perpendicular magnetic recording medium.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A perpendicular magnetic recording medium, comprising:
a non-magnetic substrate; and
a magnetic recording layer that is provided over the non-magnetic substrate and that comprises:
a first magnetic recording layer that includes first magnetic crystal grains containing an ordered alloy and a first non-magnetic portion containing carbon;
at least one second magnetic recording layer that has a film thickness t2 that ranges from 0.1 nm to 7.0 nm and that includes second magnetic crystal grains containing an ordered alloy and a second non-magnetic portion containing ZnO having a volume fraction x2 in the second magnetic recording layer at completion of formation of the at least one second magnetic recording layer that ranges from 0.20 to 0.90; and
at least one third magnetic recording layer that has a film thickness t3 that ranges from 0.5 nm to 4.0 nm, and that includes third magnetic crystal grains containing an ordered alloy and a third non-magnetic portion containing carbon that has a volume fraction x3 in the at least one third magnetic recording layer that ranges from 0.20 to 0.70,
wherein the at least one second magnetic recording layers and the at least one of third magnetic recording layers are alternately stacked over the first magnetic recording layer, and
wherein (t2/t3)×(x2/x3) ranges from 0.30 to 1.20.

2. The perpendicular magnetic recording medium according to claim 1, wherein the magnetic recording layer includes the first magnetic recording layer, one second magnetic recording layer of the at least one second magnetic recording layer, and one third magnetic recording layer of the at least one third magnetic recording layer.

3. The perpendicular magnetic recording medium according to claim 1, wherein (t2/t3)×(x2/x3) ranges from 0.45 to 1.0.

4. The perpendicular magnetic recording medium according to claim 1, wherein the first magnetic recording layer has a film thickness that ranges from 0.5 nm to 4.0 nm and the first non-magnetic portion has a volume fraction in the first magnetic recording layer that ranges from 0.10 to 0.60.

5. The perpendicular magnetic recording medium according to claim 1, wherein the ordered alloy in the first magnetic recording layer, the ordered alloy in the at least one second magnetic recording layer, and the ordered alloy in the at least one third magnetic recording layer are respectively selected from the group consisting of FePt, CoPt, FePd, and CoPd.

6. The perpendicular magnetic recording medium according to claim 1,
wherein the first magnetic recording layer has a granular structure in which the first magnetic crystal grains containing the ordered alloy are surrounded by the first non-magnetic portion containing carbon,
wherein the second magnetic recording layer has a granular structure in which the second magnetic crystal grains containing the ordered alloy are surrounded by the second non-magnetic portion containing ZnO, and
wherein the third magnetic recording layer has a granular structure in which the third magnetic crystal grains containing the ordered alloy are surrounded by the third non-magnetic portion containing carbon.

7. The perpendicular magnetic recording medium according to claim 1, further comprising a seed layer provided between the non-magnetic substrate and the magnetic recording layer; and a protection layer provided on the magnetic recording layer.

8. A method of manufacturing a perpendicular magnetic recording medium comprising a non-magnetic substrate; and a magnetic recording layer that is formed over the-non-magnetic substrate and that comprises:
a first magnetic recording layer including first magnetic crystal grains containing an ordered alloy and a first non-magnetic portion containing carbon;
at least one second magnetic recording layer including second magnetic crystal grains containing an ordered alloy and a second non-magnetic portion containing ZnO; and
at least one third magnetic recording layer including third magnetic crystal grains containing an ordered alloy and a third non-magnetic portion containing carbon,
wherein the at least one second magnetic recording layer and the at least one third magnetic recording layer are alternately stacked over the first magnetic recording layer, the method comprising:
forming the first magnetic recording layer over the non-magnetic substrate;
forming the at least one second magnetic recording layer on the first magnetic recording layer such that the second magnetic recording layer has a film thickness t2 that ranges from 0.1 nm to 7.0 nm and the second non-magnetic portion in the second magnetic recording layer has a volume fraction x2 that ranges from 0.20 to 0.90; and
forming the at least one third magnetic recording layer on the at least one second magnetic recording layer such that the at least one third magnetic recording layer has a film thickness t3 that ranges from 0.5 nm to 4.0 nm and the third non-magnetic portion in the at least one third magnetic recording layer has a volume fraction x3 that ranges from 0.20 to 0.70, and (t2/t3)×(x2/x3) ranges from 0.30 to 1.20.

9. The manufacturing method according to claim 8, comprising a step of forming the first magnetic recording layer, a step of forming the one second magnetic recording layer, and a step of forming the one third magnetic recording layer in this order.

10. The manufacturing method according to claim 9, further comprising a step of forming another one of the at least one second magnetic recording layer on the one third magnetic recording layer.

11. The manufacturing method according to claim 10, further comprising a step of forming another one of the at least one third magnetic recording layer on the other second magnetic recording layer.

12. The manufacturing method according to claim 9,
wherein formation of another second magnetic recording layer and formation of another third magnetic recording layer are alternately repeated so that the uppermost layer of the magnetic recording layer is the second magnetic recording layer or the third magnetic recording layer over the one third magnetic recording layer.

13. The manufacturing method according to claim 8, wherein (t2/t3)×(x2/x3) ranging from 0.45 to 1.0.

14. The manufacturing method according to claim 8, wherein forming the first magnetic recording layer results in the first magnetic recording layer having a film thickness t1 that ranges from 0.5 nm to 4.0 nm and the first non-magnetic portion in the first magnetic recording layer having a volume fraction x1 that ranges from 0.10 to 0.60.

15. The manufacturing method according to claim 8, wherein the ordered alloy in the first magnetic recording layer, the ordered alloy in the second magnetic recording layer, and the ordered alloy in the third magnetic recording layer are respectively selected from the group consisting of FePt, CoPt, FePd, and CoPd.

16. The manufacturing method according to claim 8,
wherein the first magnetic recording layer has a granular structure in which the first magnetic crystal grains containing the ordered alloy are surrounded by the first non-magnetic portion containing carbon,
wherein the at least one second magnetic recording layer has a granular structure in which the second magnetic crystal grains containing the ordered alloy are surrounded by the second non-magnetic portion containing ZnO, and
wherein the at least one third magnetic recording layer has a granular structure in which the third magnetic crystal grains containing the ordered alloy are surrounded by the third non-magnetic portion containing carbon.

17. The manufacturing method according to claim 8, further comprising:
forming a seed layer between the non-magnetic substrate and the magnetic recording layer; and
forming a protection layer over the magnetic recording layer.
